(19) United States
(12) Patent Application Publication
(10) Pub. No.: US 2025/0102611 A1
(43) Pub. Date: Mar. 27, 2025

(54) Vehicle Having a Plurality of UWB Antenna Modules

(71) Applicant: Bayerische Motoren Werke Aktiengesellschaft, Muenchen (DE)

(72) Inventors: Olaf Mueller, Emmering (DE); Daniel Kuelzer, Muenchen (DE); Daniel Knobloch, Los Gatos, CA (US); Thorsten Knott, Tuntenhausen (DE)

(21) Appl. No.: 18/729,773

(22) PCT Filed: Sep. 28, 2022
(86) PCT No.: PCT/EP2022/076913

§ 371 Date: Jul. 17, 2024

(30) Foreign Application Priority Data
Jan. 31, 2022 (DE) 10 2022 102 148.3

(51) Int. Cl. G01S 5/02; G01S 5/04; H01Q 1/32; H01Q 5/25

(52) U.S. Cl. CPC G01S 5/02213; G01S 5/04; H01Q 1/32; H01Q 5/25

(57) ABSTRACT

A vehicle is disclosed herein including a plurality of antennas for communicating via ultra-wideband (UWB) and a controller for evaluating a UWB signal of a transceiver, which is received by means of the plurality of antennas. The plurality of antennas include a first subset of one or more antennas and a second subset of one or more antennas. The controller is configured to determine a receiving direction of the signal in a first plane based on signal components of the signal received by means of the antennas of the first subset, and determine a receiving direction of the signal in a second plane based on signal components of the signal received by means of the antennas of the second subset, wherein the first plane is aligned perpendicularly to the second plane. The controller is further configured to determine a position of the transceiver relative to the vehicle based on the receiving direction of the signal in the first plane and based on a receiving direction of the signal in the second plane.

### CROSS-REFERENCE TO RELATED APPLICATIONS

The present application is the U.S. national phase of PCT Application PCT/EP2022/076913 filed on Sep. 28, 2022, which claims priority of German patent application No. 10 2022 102 148.3 filed on Jan. 31, 2022, the entire contents of which are incorporated herein by reference.

### FIELD

The present disclosure relates to a vehicle, and in particular to a vehicle having a plurality of ultra-wideband (UWB) antenna modules, and a corresponding method and computer program.

### BACKGROUND

A prerequisite for the use of what are known as keyless entry systems (also termed passive entry/passive go systems) consists in developing a secure and simultaneously robust method for how the user authorized for that is authenticated with respect to the vehicle.

This also includes a sufficiently accurate estimation of the location of the user or the authentication device, (from when a vehicle may be unlocked or should be locked), and whether the vehicle key (smartphone or classic key) is located inside or outside the vehicle, in order to issue an engine start authorization or to deny the same.

In the case of conventional keys, that is carried out using very low radio frequencies. At the moment, most passive entry systems are based on narrow-band radio technologies in the LF band (low frequency band, also long-wave band). As soon as the distance between key and vehicle is small enough, the vehicle key builds a connection to the vehicle. After the connection has been established, localization is carried out in a different LF frequency band. In this case, a defined signal is sent by the key and one or more receiving antennas receive this signal with different signal strengths, depending on the position in relation to the vehicle. The reason for this is the attenuation of an electromagnetic wave in various materials. Depending on the received power of the signal at the various receiving nodes, it is possible to decide whether the key is located close enough to the vehicle or is located inside the vehicle.

When implementing this function in smartphones (programmable mobile telephones), high-frequency radio frequencies can be used for localization, which make localization difficult.

There is a need for an improved concept for localizing mobile transceivers relatively to a vehicle.

### SUMMARY

One exemplary embodiment of the disclosure is concerned with a vehicle. The vehicle comprises a plurality of antenna modules for communicating via ultra-wideband (UWB). The plurality of antenna modules comprises a first subset of one or more antenna modules and a second subset of one or more antenna modules. The vehicle comprises a control device for evaluating a UWB signal of a transceiver, which is received by means of the plurality of antenna modules. The control device is designed for determining a receiving direction of the signal in a first plane based on signal components of the signal received by means of the antenna modules of the first subset. The control device is designed for determining a receiving direction of the signal in a second plane based on signal components of the signal received by means of the antenna modules of the second subset. The first plane is aligned perpendicularly to the second plane. The control device is designed for determining a position of the transceiver relative to the vehicle based on the receiving direction of the signal in the first plane and based on a receiving direction of the signal in the second plane.

One exemplary embodiment of the disclosure is concerned with a method for determining a position of a transceiver relative to the vehicle. The method comprises evaluating a UWB signal of a transceiver, which is received by means of a plurality of antenna modules. The plurality of antenna modules comprises a first subset of one or more antenna modules and a second subset of one or more antenna modules. The method further comprises determining a receiving direction of the signal in a first plane based on signal components of the signal received by means of the antenna modules of the first subset. The method further comprises determining a receiving direction of the signal in a second plane based on signal components of the signal received by means of the antenna modules of the second subset, wherein the first plane is aligned perpendicularly to the second plane. The method further comprises determining a position of the transceiver relative to the vehicle based on the receiving direction of the signal in the first plane and based on a receiving direction of the signal in the second plane.

One exemplary embodiment of the disclosure is concerned with a program having program code for carrying out the above method when the program code is executed on a computer, a processor, a control module or a programmable hardware component.

By using two groups of antenna modules, which are used for position determination in different planes (for example the X-Y plane and Y-Z plane or X-Z plane), a highly accurate determination of the position of the transceiver in a 3D coordinate system is enabled.

### BRIEF DESCRIPTION OF THE DRAWINGS

A few examples of devices and/or methods are explained in more detail below merely by way of example with reference to the attached figures. In the figures:

FIG. 1a shows a schematic drawing of an example of a vehicle;

FIG. 1b shows a flow chart of an example of a method for determining a position of a transceiver relative to a vehicle;

FIG. 2 shows a schematic drawing of an example of an antenna module;

FIG. 3 shows a schematic drawing of the dimensions of a coordinate system;

FIGS. 4a to 4g show schematic drawings of a further example of a vehicle;

FIG. 5 shows a schematic drawing of a further example of an antenna module; and

FIGS. 6a to 6g show schematic drawings of a further example of a vehicle.

### DESCRIPTION

A few exemplary embodiments are now described in further detail with reference to the attached figures. However, it will be recognized that further possible examples are not limited to the features of these embodiments which are described in detail. These may have modifications of the features and also equivalences and alternatives to the features. Furthermore, the terminology that is used here for describing certain examples should not be limiting for further possible examples.

The same or similar reference signs relate in the entire description of the figures to the same or similar elements or features which may in each case be implemented in an identical manner or else in a modified form, while they provide the same or a similar function. In the figures, the thicknesses of lines, layers and/or areas may further be exaggerated for clarification.

If two elements A and B are combined using an “or”, this is to be understood such that all possible combinations are disclosed, i.e. only A, only B and also A and B, as long as not expressly defined differently in a particular case. As an alternative formulation for the same combinations, “at least one of A and B” or “A and/or B” can be used. This is true equivalently for combinations of more than two elements.

If a singular form, e.g. “a, an” and “the”, is used and the use of only one single element is defined as compulsory neither explicitly nor implicitly, further examples can also use a plurality of elements in order to implement the same function. If a function is described below as implemented using a plurality of elements, further examples can implement the same function using a single element or a single processing entity. Furthermore, it is understood that the terms “comprises”, “comprising”, “has” and/or “having” when used describe the presence of the specified features, whole numbers, steps, operations, processes, elements, components and/or a group of the same, but in the process do not exclude the presence or the addition of one or more other features, whole numbers, steps, operations, processes, elements, components and/or a group of the same.

Various exemplary embodiments are concerned with a design and positioning of transceivers of a vehicle UWB system for a vehicle entry system.

The present concept is concerned in particular with a design of an improved vehicle entry system. Existing systems that are used in vehicle entry systems generally do not support any measurement of the angle of arrival (AoA) of a signal of an entry device, as corresponding components permitted for use in vehicles are not available. These systems therefore have fewer requirements on the positioning of the transceivers. Also, such systems often only support 2D localization based on time-of-flight (ToF) measurements.

In the present concept, an increase in the localization accuracy is achieved by using ultra-wideband (UWB). Also, an expansion of the position determination to 3D positioning (by adding the Z axis) and a reduction of ambiguities are enabled. As a result, novel types of use are enabled, such as what is known as “ceremonial access” or touchless operation of and hatches doors. An improvement of the robustness and localization error reduction can be achieved by the chosen design and positions.

In some exemplary embodiments, the design and installation of UWB transceivers (UWB antenna modules) in a vehicle is configured such that on the one hand the input angle can be measured using polarization diversity and on the other hand the position of the digital key (CCC digital key) can be determined in three-dimensional space and in addition a structurally identical component can be used for all positions.

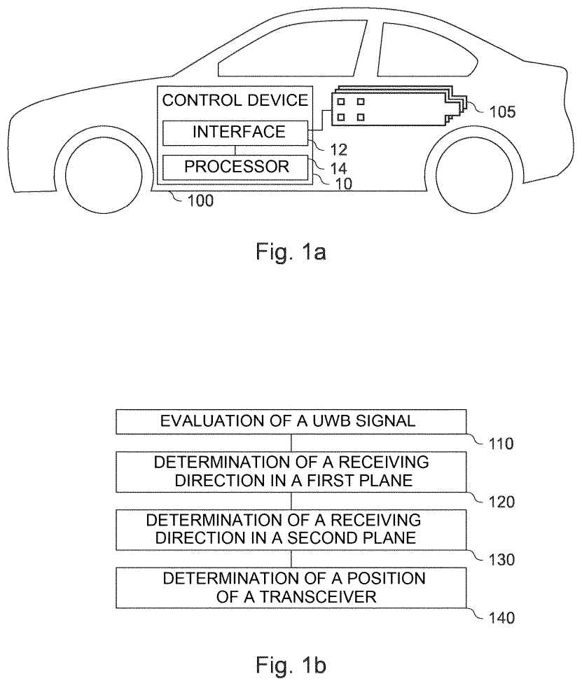

FIG. 1a shows a schematic drawing of an example of a vehicle 100 having a plurality of UWB antenna modules for communication via UWB and a control device 10. The plurality of antenna modules 105 comprises a first subset of one or more antenna modules and a second subset of one or more antenna modules. The control device is designed for evaluating a UWB signal of an (external) transceiver, which is received by means of the plurality of antenna modules. For example, the control device 10 can, as is shown in FIG. 1a, comprise an interface 12 (for communicating with the antenna modules 105) and a processor 14 which is coupled to the interface 14 and provides the calculation functionality of the control device. The control device 10 is designed for determining a receiving direction of the signal in a first plane based on signal components of the signal received by means of the antenna modules of the first subset. The control device 10 is designed for determining a receiving direction of the signal in a second plane based on signal components of the signal received by means of the antenna modules of the second subset. The first plane is aligned perpendicularly to the second plane. The control device 10 is designed for determining a position of the transceiver relative to the vehicle based on the receiving direction of the signal in the first plane and based on a receiving direction of the signal in the second plane.

FIG. 1b shows a flow chart of an example of a corresponding method for determining the position of the transceiver relative to the vehicle. For example, the method can be carried out by the control device 10 with the aid of the antenna modules 105. The method comprises evaluating 110 the UWB signal of the transceiver, which is received by means of the plurality of antenna modules. The method further comprises determining 120 the receiving direction of the signal in the first plane based on components of the signal received by means of the antenna modules of the first subset. The method further comprises determining 130 the receiving direction of the signal in the second plane based on signal components of the signal received by means of the antenna modules of the second subset. The method further comprises determining 140 the position of the transceiver relative to the vehicle based on the receiving direction of the signal in the first plane and based on a receiving direction of the signal in the second plane.

Some examples of the present disclosure further relate to a program having program code for carrying out the method of FIG. 1b when the program code is executed on a computer, a processor, a control module or a programmable hardware component. For example, the program code can be executed on the control device 10.

Below, the functionality of the vehicle 100, the control device 10, the antenna modules 105, the method and the computer program is explained with reference to the vehicle 100, the control device 10 and the antenna modules 105. Features, which can be introduced with reference to the vehicle 100, the control device 10 and the antenna modules 105, can likewise be incorporated into the corresponding method and computer program.

The present disclosure is based on the use of a plurality of UWB antenna modules for the localization of the position of a transceiver. In this case, the transceiver can for example be a UWB vehicle key, i.e. a vehicle key which sends a UWB signal which can be used by the control device for locating the vehicle key. Alternatively, the transceiver may be a mobile device, for example a programmable mobile telephone (smartphone), what is known as a wearable (a mobile device that can be worn as an accessory), such as for example a programmable watch (smartwatch) or a fitness tracker.

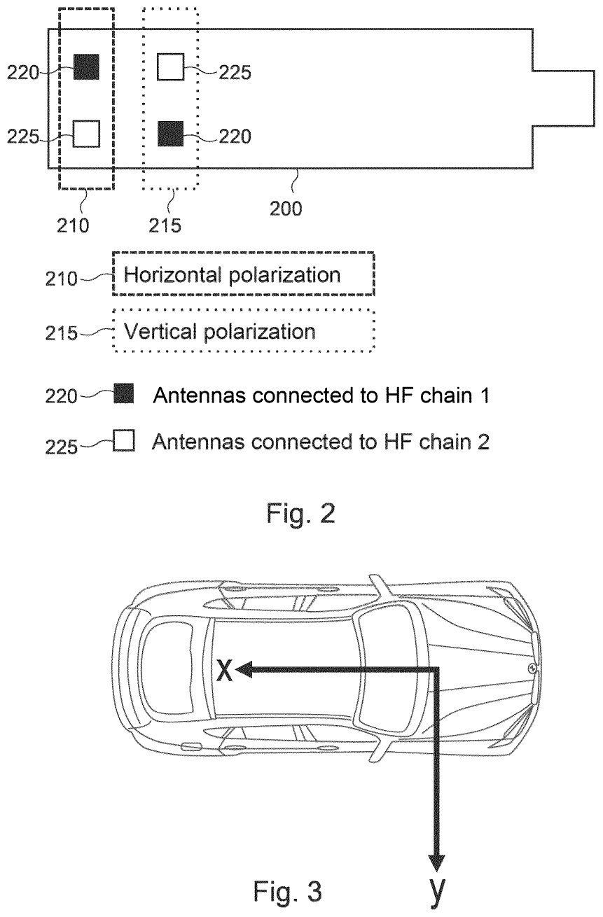

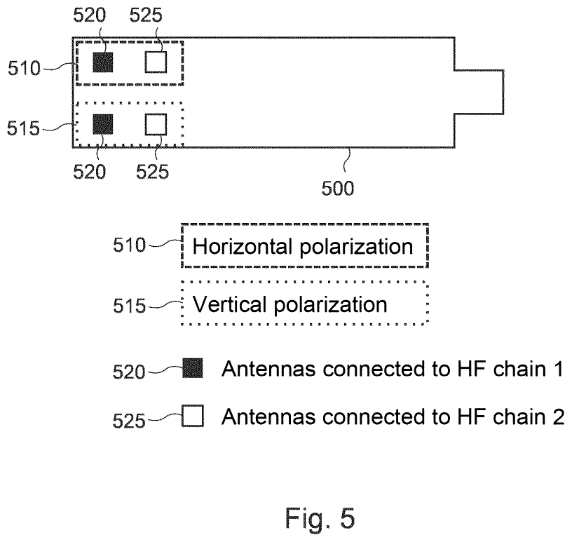

The vehicle comprises the plurality of antenna modules 105 which are arranged at various locations in the vehicle. The term “antenna modules” is used below, as each antenna module can comprise various components, such as for example a plurality of antennas and/or a plurality of transceiver components. However, it will be recognized that the term “antenna” is also used herein to refer to a device that can comprise various components, such as for example a plurality of antennas and/or a plurality of transceiver components. As shown in FIGS. 2 and 5, the antenna modules can for example comprise antennas 220; 225; 520; 525. In FIGS. 2 and 5, the antenna modules shown there comprise four antennas in each case for example, wherein in each case two antennas are connected to a HF (high-frequency) transceiving chain having a corresponding transceiver circuit. Using these two antennas, which are connected to a HF transceiving chain in each case, polarization diversity can additionally be used, i.e. the two antennas can be used in different polarization directions (for example in that one of the antennas is used for a first polarization direction and the other antenna is used for a second polarization direction). In other words, the antenna modules can comprise two groups of antennas in each case. The control device can be designed to evaluate signals of a first polarization direction by means of the first of the two groups of antennas and to evaluate signals of a second polarization direction by means of the second of the two groups of antennas. This increases the robustness of the position detection.

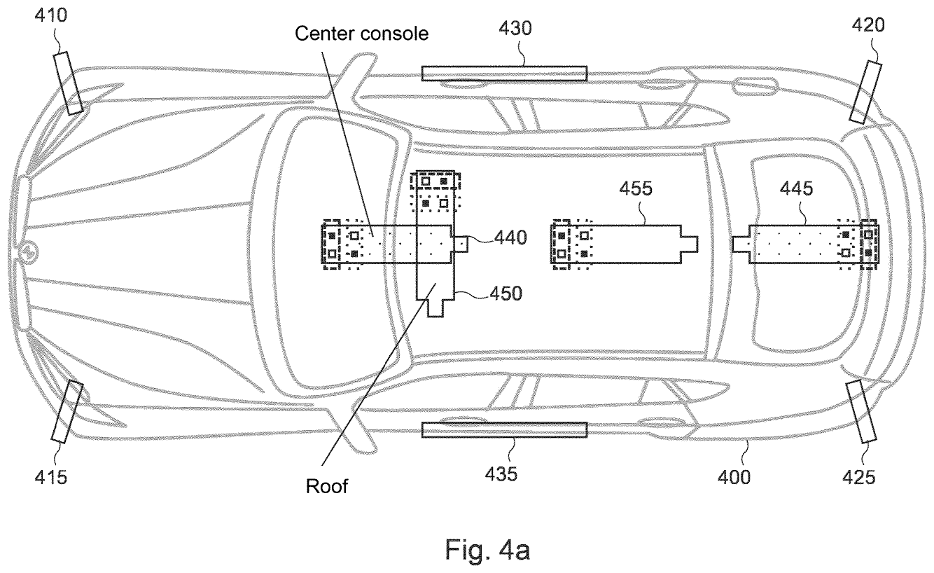

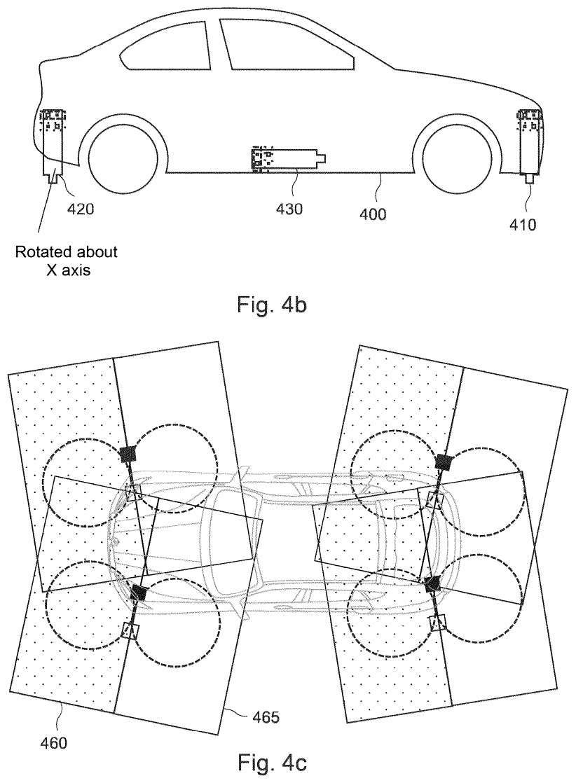

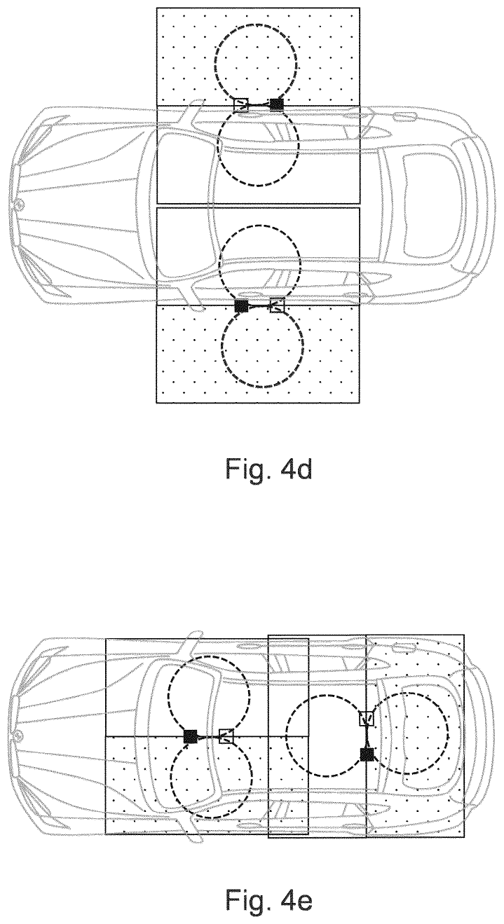

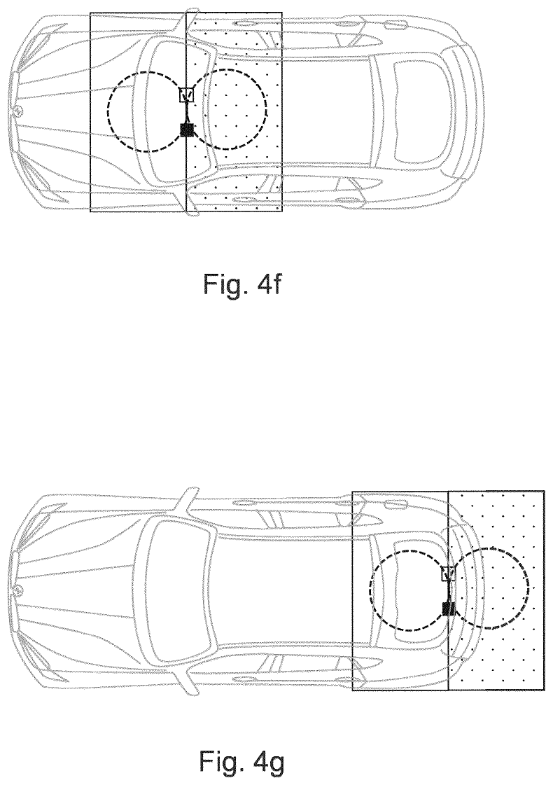

In the present disclosure, a plurality of antenna modules are used. As becomes clear in FIGS. 4a to 4g and also 6a to 6e, the same antenna module can in this case be used at different positions in the vehicle. In other words, the antenna modules can be constructed identically. This can lower the production outlay.

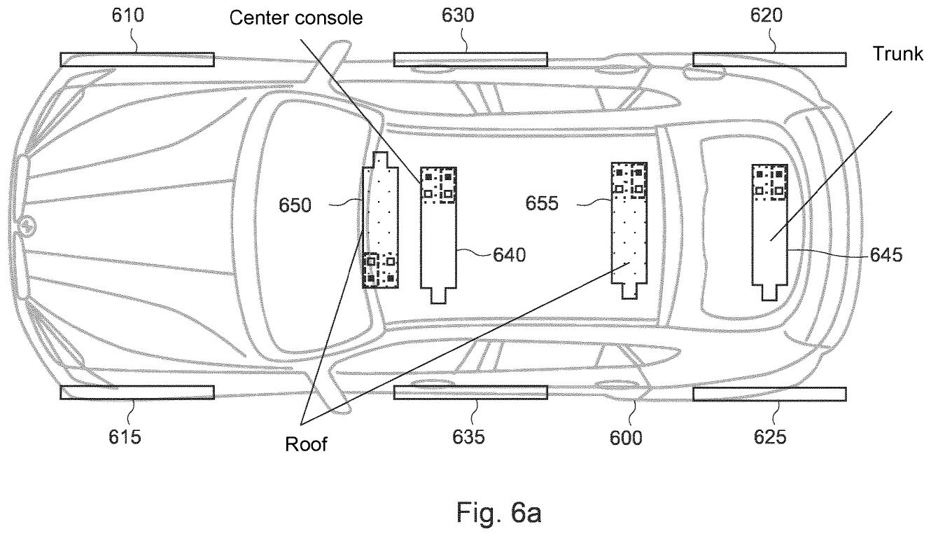

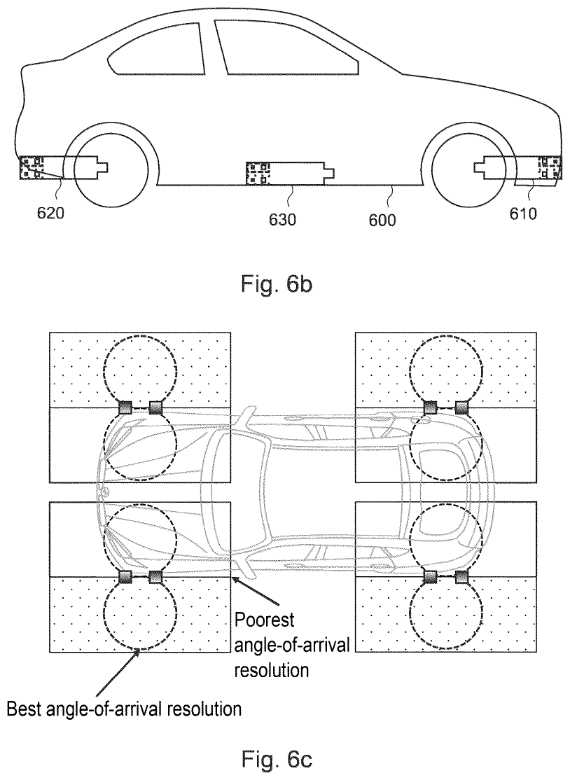

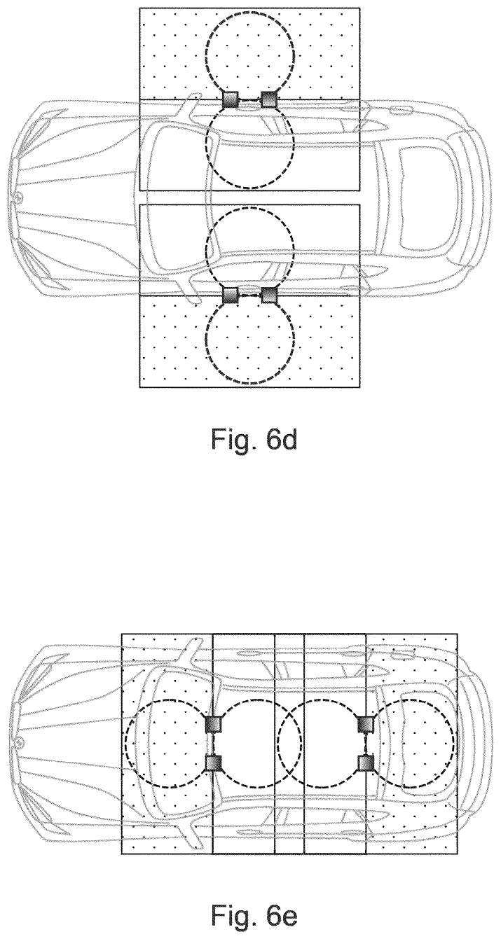

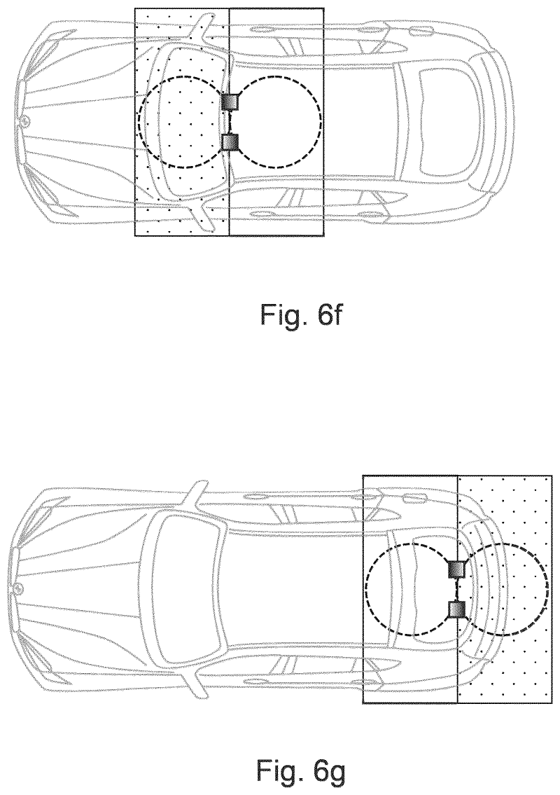

In this case, the antenna modules are divided into two groups of (non-overlapping) subsets—a first group, in order to determine the receiving direction (for example the “angle of arrival” (AoA)) in the first plane, and a second group, in order to determine the receiving direction in the second plane. Below, it is assumed that the first plane is the X-Y plane and the second plane is the X-Z or Y-Z plane (see FIG. 3). In other words, the first plane extends along the longitudinal axis (X axis) of the vehicle, for example between longitudinal axis and transverse axis (Y axis) of the vehicle, and the second plane extends along the vertical axis (Z axis) of the vehicle, for example between the transverse axis and the vertical axis or between the longitudinal axis and the vertical axis of the vehicle. In this case, the focus lies on the first plane, i.e. the position of the transceiver in the X-Y plane. Therefore, a larger proportion of the antenna modules, as shown in FIGS. 4a to 4g and 6a to 6g, is assigned to the first subset and a smaller proportion of the antenna modules is assigned to the second subset.

For example, the first subset can comprise four antenna modules which are arranged at the corners of the vehicle, for example the antenna modules 410; 415; 420; 425 in FIG. 4a and also 610; 615; 620; 625 in FIG. 6a. Additionally (or alternatively), the first subset can comprise two antenna modules which are arranged at the sides of the vehicle (antenna modules 630; in 635 FIG. 6a). Alternatively, the antenna modules which are arranged at the sides of the vehicle are assigned to the second subset (antenna modules 430; 435 in FIG. 4a). However, the antenna modules of the first subset are not limited to the exterior space of the vehicle. Thus, the first subset can comprise at least one antenna module which is arranged in a center console (antenna module 440 in FIG. 4a or 640 in FIG. 6a) or in the trunk (antenna module 445 in FIG. 4a or 645 in FIG. 6a) in the interior of the vehicle. In other words, the first subset of antenna modules can comprise at least one antenna module, which is arranged in the interior of the vehicle, and at least one antenna module, which is arranged outside the interior of the vehicle.

The antenna modules of the second subset are used for localization along the vertical axis (Z axis). In this case, the antenna modules of the second subset of antenna modules can be arranged in the interior of the vehicle, for example in the vehicle roof in the interior of the vehicle (antenna modules 650; 655 in FIG. 6a). Alternatively, the antenna modules of the second subset can be arranged outside the vehicle interior, for example in the side skirts (antenna modules 430; 435 in FIG. 4a).

In some configurations, the antenna modules can be aligned such that the measuring areas thereof overlap at particularly important locations. One such location is for example the region outside the front vehicle doors (driver's door and passenger door). For example, in each case two of the four antenna modules, which are arranged at the corners of the vehicle, can be arranged such that an angle of arrival measurement takes place with the highest accuracy at the side of the vehicle, for example in front of the driver's or passenger door. This is shown in FIG. 4c, where the region with the highest angle of arrival resolution (in a two-dimensional illustration) is drawn as dashed circles. The antenna diagram is for the most part omnidirectional in the X-Y plane, but the angular measurement is more accurate in some directions owing to the physical circumstances (arrangement of the antennas). If one extends opposite areas with the highest angle-of-arrival resolution of the antenna modules 415 and 425, then these areas overlap in front of the driver's door, while two areas with the highest angle-of-arrival resolution of the antenna modules 410; 420 overlap in front of the passenger door. Each antenna module is shown here with two measuring areas (460; 465 in FIG. 4c) and therefore also two areas with the highest angle-of-arrival resolution, from which the ambiguity of the determination of the angle of arrival results. The poorest angle-of-arrival resolution in this case is to be expected between the measuring areas, while the best angle-of-arrival resolution is to be expected along the areas with the highest angle-of-arrival resolution. As is shown in FIG. 6c, the antenna modules, which are arranged at the four corners, can also be arranged such that the areas with the highest angle-of-arrival resolution do not overlap in front of the vehicle doors.

The control device is then used for determining the position of the transceiver. To this end, the respective signal components of the signal, for example the signal strength of the signal components, the time offset of the signal components and/or the phase shift of the signal components are analyzed in order to localize the transceiver in the two planes. In this case, the position is determined in two planes in order to obtain a 3D position of the transceiver. In other words, the control device can be designed to determine the position of the transceiver in a 3D coordinate system.

In this case, generally at least three approaches can be used—the determination of the receiving direction by means of the signal strength, which is measured by means of the respective antenna modules, the determination of the receiving direction by means of the angle of arrival of the respective signal components or the determination of the receiving direction/position based on a machine learning model. For example, a combination of at least two of the above-described measures can be used or the machine learning model can be used to implement one of the two other measures. In principle however, all three measures are suitable for determining the respective receiving direction.

The control device is designed for determining the receiving direction of the signal in the first plane based on signal components of the signal received by means of the antenna modules of the first subset and for determining the receiving direction of the signal in the second plane based on signal components of the signal received by means of the antenna modules of the second subset. As explained previously, the first plane is formed along the longitudinal axis (X axis) and along the transverse axis (Y axis) of the vehicle and the second plane is formed along the vertical axis (Z axis) and along the longitudinal or transverse axis. In reality, the angle-of-arrival measurement does not necessarily take place in a plane which is formed by the previously mentioned axes, but rather relatively to the axis on which the respective antennas of the antenna module are located. However, the measured angles, particularly in the outside area, can be projected with a small error into the respective plane (for example the X-Y plane, as the distance in the X-Y plane is larger than along the Z plane). If reference is made below to the X, Y or Z axis (longitudinal axis, transverse axis or vertical axis) and the X-Y, X-Z or Y-Z plane, then reference can be made, depending on the implementation, to the axes and planes which are formed by the vehicle and also to the axes and planes which are approximately similar thereto and which are formed by the arrangement of the antennas.

The position of the transceiver in the X direction can in this case be determined on the basis of the received signal strength of the signal components. For example, the control device can be designed to determine the position of the transceiver in a first dimension along the longitudinal axis (X axis) of the vehicle based on a strength of the received signal respective signal components determined by means of the respective antenna modules. The position of the transceiver in the Y direction and Z direction can take place by contrast by means of the phase shift of the signal components. The control device can therefore be designed to determine the position of the transceiver in a second dimension along the transverse axis of the vehicle and/or in a third dimension along the vertical axis of the vehicle based on a phase difference of arrival of the respective signal components. The position of the transceiver in the 3D coordinate system (relative to the vehicle) then results from the position of the transceiver in the first dimension along the longitudinal axis, the position of the transceiver in the second dimension along the transverse axis, and the position of the transceiver in the third dimension along the vertical axis. In this case, the determination of the first receiving direction can for example comprise the determination of the position of the transceiver in the first dimension along the longitudinal axis and the position of the transceiver in the second dimension along the transverse axis. The determination the second receiving direction can comprise the determination of the position of the transceiver in the third dimension along the vertical axis and, optionally, the determination of the position of the transceiver in the first or second dimension along the longitudinal or transverse axis.

In principle, the receiving directions and/or positions can be determined by means of triangulation of the signal. In a few implementations, however, instead or in addition thereto, the respective receiving direction or position can be determined by means of machine learning. Machine learning can relate to algorithms and statistical models which computer systems can use in order to carry out a particular task without using explicit instructions instead of relying on models and inference. In machine learning for example, instead of a transformation of data based on rules, a transformation of data can be used, which can be derived from an analysis of historical and/or training data. For example, the content of images can be analyzed using a machine learning model or using a machine learning algorithm. So that the machine learning model can analyze the content of an image, the machine learning model can be trained using training images as input and training content information as output. By training the machine learning model using a large number of training images and/or training sequences (e.g. words or sentences) and associated training content information (e.g. labels or comments), the machine learning model “learns” to recognize the content of the images, so that the content of images which are not included in the training data can be recognized using the machine learning model. The same principle can likewise be used for other types of sensor data: by training a machine learning model using training sensor data and a desired output, the machine learning model “learns” a transformation between the sensor data and the output, which can be used to provide an output based on non-training sensor data provided to the machine learning model. The data provided (e.g. sensor data, metadata and/or image data) can be preprocessed in order to obtain a feature vector which is used as input for the machine learning model.

Machine learning models can be trained using training input data. The above-mentioned examples use a training method that is called “supervised learning”. In supervised learning, the machine learning model is trained using a plurality of training samples, wherein each sample can comprise a plurality of input data values and a plurality of desired output values, i.e. a desired output value is assigned to each training sample. By specifying both training samples and desired output values, the machine learning model “learns” which output value is to be provided based on an input sample which is similar to the samples provided during the training.

Such an approach can also be chosen here. The control device can be designed to determine the respective receiving direction and/or the position of the transceiver with the aid of a machine learning model. The machine learning model can be trained to output the first receiving direction, the second receiving direction and/or the position of the transceiver based on a feature vector which represents the respective signal components of the signal. To this end, the machine learning model can be trained by means of supervised learning, wherein (by means of measurements or simulatively determined) feature vectors can be used as training samples and the corresponding receiving direction or position of the transceiver can be used as desired output values.

Machine learning algorithms are normally based on a machine learning model. In other words, the term “machine learning algorithm” can designate a set of instructions that can be used in order to create, to train or to use a machine learning model. The term “machine learning model” can designate a data structure and/or a set of rules which represents the learned knowledge (e.g. based on the training carried out by the machine learning algorithm). In exemplary embodiments, the use of a machine learning algorithm may imply the use of an underlying machine learning model (or a plurality of underlying machine learning models). The use of a machine learning model may imply that the machine learning model and/or the data structure/the set of rules, which is/are the machine learning model, is trained by a machine learning algorithm.

For example, the machine learning model can be an artificial neural network (ANN). ANNs are systems which are inspired by biological neural networks as are to be found in a retina or a brain. ANNs comprise a plurality of interconnected nodes and a plurality of connections, which are known as edges, between the nodes. Normally, there are three node types, input nodes, which receive input values, hidden nodes, which are (only) connected to other nodes, and output nodes, which provide output values. Each node can represent an artificial neuron. Each edge can send information from one node to the other. The output of a node can be defined as a (nonlinear) function of the inputs (e.g. the sum of its inputs). The inputs of a node can be used in the function based on a “weight” of the edge or the node which provides the input. The weight of nodes and/or of edges can be adjusted in the learning process. In other words, the training of an artificial neural network can comprise an adjustment of the weights of the nodes and/or edges of the artificial neural network, i.e. in order to achieve a desired output for a certain input.

The interface 12 can for example correspond to one or more inputs and/or one or more outputs for receiving and/or transmitting information, for example in digital bit values, based on a code, inside a module, between modules, or between modules of different entities.

In exemplary embodiments, the processor 14 can correspond to any desired controller or processor or a progammable hardware component. For example, the processor 14 can also be realized as software that is programmed for a corresponding hardware component. In this respect, the processor 14 can be implemented as programmable hardware with correspondingly adapted software. In this case, any desired processors, such as digital signal processors (DSPs), can be used. Exemplary embodiments are not limited to a certain type of processor in this case. Any desired processors or else a plurality of processors are conceivable for implementation.

More details and aspects of the vehicle, the control device, the method and the computer program are mentioned in connection with the concept or examples that are described beforehand or subsequently (e.g. FIGS. 2 to 6g).

The vehicle, the control device, the vehicle and the computer program can comprise one or more additional optional features which correspond to one or more aspects of the proposed concept or the described examples, as are described beforehand or subsequently.

FIG. 2 shows a schematic drawing of an example of an antenna module (i.e. a UWB transceiver or anchor). In the examples shown in FIGS. 2 to 6, each individual UWB transceiver 200 (antenna module or anchor) is equipped with two HF (radio frequency, also RF) chains and four antennas. FIG. 2 shows the antennas 220 which are connected to the first HF chain and the antennas 225 which are connected to the second HF chain. Therefore, it is possible to switch between two antenna pairs. In each case, two antennas are polarized in the same way and form an antenna pair. FIG. 2 shows the division of the antennas into antennas 210, which form the horizontally polarized antenna pair, and antennas 215, which form the vertically polarized antenna pair. Each antenna pair can determine an angle (in a plane with a 180° resolution) by means of PDoA (phase difference of arrival, phase difference of the arriving signal). By means of the proposed antenna modules, the measurement of the angle of arrival can be carried out using polarization diversity.

Below, the designations X, Y and Z axis of a 3D coordinate system, which is defined relative to the vehicle, are used. FIG. 3 shows a schematic drawing of the dimensions of the coordinate system. The Z axis follows from the right-hand rule. It is possible to see that the X axis corresponds to the longitudinal axis of the vehicle, the Y axis to the transverse axis of the vehicle and the Z axis to the vertical axis of vehicle. This coordinate system is used below by way of example for the 3D localization of the digital key presented in FIGS. 2 to 6.

In order to enable 3D position determination in and around the vehicle, ten antenna modules in total are installed in a fully completed state. FIG. 4a shows a schematic drawing of an overview across the positions of the antenna modules in an exemplary embodiment. FIG. 4a shows a schematic drawing of the corresponding side view of the antenna modules.

Four anchors are installed in the four corners of the vehicle (410 at the front right vehicle corner, 415 at the front left vehicle corner, 420 at the rear right vehicle corner and 425 at the rear left vehicle corner in FIGS. 4a to 4g and also 610 at the front right vehicle corner, 615 at the front left vehicle corner, 620 at the rear right vehicle corner and 625 at the rear left vehicle corner in FIGS. 6a to 6g), so that a cable (e.g. CAN-FD, Controller Area Network Flexible Data Rate, control network having a flexible data rate) can be led away downward. The antenna modules at the vehicle corners (as attachment of the antenna modules 410 and 420 is shown in FIG. 4a) can be rotated about the Z axis. Using these anchors, the angle (outside of the vehicle) can be determined in the X-Y plane.

One anchor 440 can be installed in the interior in the center console and can be aligned such that it is possible to differentiate whether the digital key is located on the driver's side or passenger's side (in the X-Y plane). A further UWB transceiver 445 can be installed in the trunk and can measure the angle with respect to the tailgate opening (X-Y plane). Two anchors 430, 435 can be attached centrally on the driver's or passenger's side in the sill and can, in some exemplary embodiments, be orientated such that the angle can be measured relative to the Z axis (for example in the Y-Z plane). Two further UWB transceivers 450, 455 can be located in the roofliner, front and rear, and have a position rotated by 90° in the X-Y plane, so that in total a 360° angle determination is possible.

FIGS. 4c to 4g show schematic drawings of the respective coverage areas of the antenna modules. The rectangles 460 and 465 show two different measuring areas of an antenna module, between which, starting from an individual antenna module, it is not possible to differentiate with respect to the entry angle measurement. The rectangles drawn in FIGS. 4c to 4g only indicate the coverage areas—in reality, UWB has a considerably larger range of at least 10 meters.

FIG. 4c shows how the outer anchors at the vehicle corners (410, 415, 420, 425) measure the input angle in the X-Y plane. FIG. 4d shows how the outer anchors at the sides of the vehicle measure the angle in the Y-Z plane. FIG. 4e shows how the inner anchors that are attached in the roofliner measure the angle in the X-Y plane. It is to be taken into account in this case that the details relate to an angle relative to an axis. The two antennas are located on this axis. In FIG. 4e, thanks to two axes which are perpendicular to one another, it is possible on the one hand using the rear transceiver to differentiate between driver and passenger and on the other hand using the front transceiver to differentiate between front and rear. In addition, by combining these two pieces of information (and the distance in each case), it is possible to determine a 3D localization in the interior. FIG. 4f shows how the inner anchor in the center console measures the angle in the X-Y plane and therefore enables or improves the differentiation between driver and passenger. FIG. 4g shows how the inner anchor in the trunk measures the angle in the X-Y plane.

More details and aspects of the vehicle and the antenna modules are mentioned in connection with the concept or examples that are described beforehand or subsequently (e.g. FIGS. 1a to 1b, 5 to 6g). The vehicle and the antenna modules can comprise one or more additional optional features which correspond to one or more aspects of the proposed concept or the described examples, as are described beforehand or subsequently.

FIGS. 5 and 6a to 6g show an alternative configuration of the antenna modules and placement of the antenna modules. FIG. 5 shows the antennas 520 which are connected to the first HF chain and the antennas 525 which are connected to the second HF chain. Therefore, it is possible to switch between two antenna pairs. In each case, two antennas are polarized in the same way and form an antenna pair. Compared to the example of FIG. 2, the polarization pairs are formed along the longitudinal axis of the antenna module 500 however and not at right angles thereto. Also, in FIG. 2, the antennas are arranged crosswise, but in FIG. 5 in pairs according to the HF chain. In both cases, one polarization pair comprises one antenna of each HF chain. FIG. 5 shows the division of the antennas into antennas 510 which form the horizontally polarized antenna pair and antennas 515 which form the vertically polarized antenna pair. Each antenna pair can determine an angle (in a plane with a 180° resolution) by means of PDoA (phase difference of arrival, phase difference of the arriving signal). By means of the proposed antenna modules, the measurement of the angle of arrival can be carried out using polarization diversity. The additional polarization is optional however, just as in FIG. 2, and is used for improving the robustness.

FIG. 6a shows a schematic drawing of an overview across the positions of the antenna modules in a further exemplary embodiment. FIG. 6a shows a schematic drawing of the corresponding side view of the antenna modules.

Again, in the fully completed state, four antenna modules 610, 615, 620 and 625 are arranged at the four vehicle corners, two antenna modules 630, 635 are arranged in the sills at the side of the vehicle, one antenna module 640 is arranged in the center console, one antenna module 645 is arranged in the trunk and two antenna modules 650, 655 are arranged in the roofliner. In contrast to the example of FIGS. 4a to 4g, the antennas in the roofliner are used in the present case to determine the position of the transceiver in the Y-Z plane.

FIG. 6c shows how the outer anchors at the vehicle corners (610, 615, 620, 625) measure the input angle in the X-Y plane. Again, two different measuring areas are shown for each antenna module, between which, starting from an individual antenna module, it is not possible to differentiate with respect to the entry angle measurement. The poorest angle-of-arrival resolution is to be expected between the measuring areas. The best angle-of-arrival resolution is to be expected inside the main measuring lobe (drawn as dashed circles). FIG. 6d shows how the outer anchors at the sides of the vehicle measure the angle in the X-Y plane. FIG. 6e shows how the inner anchors that are attached in the roofliner measure the angle in the Y-Z plane. The angle-of-arrival measurement is relative to the connecting line of the two antennas in this case. Thus, the angle can be projected into both planes. Using the arrangement in FIG. 6e, it is possible to differentiate between driver and passenger. FIG. 6f shows how the inner anchor in the center console measures the angle in the Y-Z plane. Here also, the differentiation between driver and passenger is paramount. As the angle can be rotated about the connecting line of the two antennas, a circle is created from angle and distance. The circle can be located either on the driver's or passenger's side. FIG. 6g shows how the inner anchor in the trunk measures the angle in the X-Y plane.

More details and aspects of the vehicle and the antenna modules are mentioned in connection with the concept or examples that are described beforehand or subsequently (e.g. FIGS. 1a to 4g). The vehicle and the antenna modules can comprise one or more additional optional features which correspond to one or more aspects of the proposed concept or the described examples, as are described beforehand or subsequently.

The aspects and features which described are in connection with a particular one of the preceding examples can also be combined with one or more of the further examples, in order to replace an identical or similar feature of this further example or in order additionally to introduce the feature into the further example.

Examples can furthermore relate to a (computer) program having program code for executing one or more of the above methods or relate thereto when the program is executed on a computer, a processor or another programmable hardware component (all of which may be collectively referred to herein as “controllers”). Steps, operations or processes of various ones of the above-described methods can therefore also be executed by programmed computers, processors or other programmable hardware components. Examples can also cover program storage devices, e.g. digital data storage media, which are machine-, processor- or computer-readable, and encode or contain machine-executable, processor-executable or computer-executable programs and instructions. The program storage devices can comprise or be e.g. digital memory, magnetic storage media, such as magnetic disks and magnetic tapes, hard disk drives or optically readable digital data storage media. Further examples can also cover computers, processors, control units, field programmable logic arrays ((F)PLAs=(field) programmable logic arrays), field programmable gate arrays ((F)PGAs=(field) programmable gate arrays), graphics processors (GPU=graphics processor unit), application specific integrated circuits (ASICs), integrated circuits (ICs) or system-on-a-chip (SoC) systems, which are programmed for executing the steps of the above-described methods.

It is further understood that the disclosure of a plurality of steps, processes, operations or functions, which are disclosed in the description or the claims, should not necessarily be construed as being in the described sequence, provided that this is not explicitly stated in the individual case or absolutely necessary for technical reasons. Therefore, due to the preceding description, carrying out a plurality of steps or functions is not limited to a certain sequence. Furthermore, in further examples, a single step, a single function, a single process or a single operation can include a plurality of sub-steps, -functions, -processes or -operations and/or be broken down into the same.

If a few aspects were described in the preceding sections in connection with a device or a system, these aspects are also to be understood as a description of the corresponding method. In this case for example, a block, a device or a functional aspect of the device or the system may correspond to a feature, for example a method step, of the corresponding method. Accordingly, aspects that are described in connection with a method are also to be understood as a description of a corresponding block, a corresponding element, a property or a functional feature of a corresponding device or a corresponding system.

The following claims are hereby incorporated into the detailed description, wherein each claim can stand alone as a separate example. Furthermore, it is to be considered that—although one dependent claim in the claims relates to a certain combination with one or more other claims—other examples may also comprise a combination of the dependent claim with the subject matter of each other dependent or independent claim. Such combinations are hereby explicitly proposed, provided that it is not explicitly stated in the individual case that a certain combination is not intended. Furthermore, features of a claim should also be included for each other independent claim, even if this claim is not directly defined as dependent on this other independent claim.

### LIST OF REFERENCE SIGNS

10 Control device
12 Interface
14 Processor
100 Vehicle
105 Antenna modules
110 Evaluation of a UWB signal
120 Determination of a receiving direction in a first plane
130 Determination of a receiving direction in a second plane
140 Determination of a position of a transceiver
200 Antenna module
210 Antennas with horizontal polarization
215 Antennas with vertical polarization
220 Antennas connected to HF chain 1
225 Antennas connected to HF chain 2
400 Vehicle
410-455 Antenna modules/anchors
460, 465 Measuring areas
500 Antenna module
510 Antennas with horizontal polarization
515 Antennas with vertical polarization
520 Antennas connected to HF chain 1
525 Antennas connected to HF chain 2
600 Vehicle
610-655 Antenna modules/anchors

1.-10. (canceled)

11. A vehicle, comprising:
a plurality of antennas for communicating via ultra-wideband, UWB, wherein the plurality of antennas comprises a first subset of one or more antennas and a second subset of one or more antennas; and
a controller for evaluating a UWB signal of a transceiver, which is received by means of the plurality of antennas, configured to:
determine a receiving direction of the signal in a first plane based on signal components of the signal received by means of the antennas of the first subset,
determine a receiving direction of the signal in a second plane based on signal components of the signal received by means of the antennas of the second subset, wherein the first plane is aligned perpendicularly to the second plane, and
determine a position of the transceiver relative to the vehicle based on the receiving direction of the signal in the first plane and based on a receiving direction of the signal in the second plane.

12. The vehicle as claimed in claim 11, wherein the controller is configured to determine the position of the transceiver in a first dimension along the longitudinal axis of the vehicle based on a received signal strength of the respective signal components determined by means of the respective antennas.

13. The vehicle as claimed in claim 11, wherein the controller is configured to determine the position of the transceiver in a second dimension along the transverse axis of the vehicle and/or in a third dimension along a vertical axis of the vehicle based on a phase difference of arrival of the respective signal components.

14. The vehicle as claimed in claim 11, wherein the antennas are constructed identically.

15. The vehicle as claimed in claim 11, wherein the first subset of antennas comprises at least one antenna module, which is arranged in the interior of the vehicle, and at least one antenna module, which is arranged outside the interior of the vehicle,
or wherein the first subset of antennas comprises four antennas which are arranged at the corners of the vehicle,
or wherein the first subset of antennas comprises two antennas which are arranged at the sides of the vehicle.

16. The vehicle as claimed in claim 15, wherein two of the four antennas, which are arranged at the corners of the vehicle, are arranged such that two areas with the highest angle-of-arrival resolution of the two antennas overlap at the side of the vehicle.

17. The vehicle as claimed in claim 11, wherein the antennas of the second subset of antennas are arranged in the interior of the vehicle.

18. The vehicle as claimed in claim 11, wherein the antennas comprise two groups of antennas in each case, wherein the controller is configured to evaluate signals of a first polarization direction by means of the first of the two groups of antennas and to evaluate signals of a second polarization direction by means of the second of the two groups of antennas.

19. A method for determining a position of a transceiver relative to the vehicle, the method comprising:
evaluating an ultra-wideband, UWB, signal of a transceiver, which is received by means of a plurality of antennas, wherein the plurality of antennas comprises a first subset of one or more antennas and a second subset of one or more antennas;
determining a receiving direction of the signal in a first plane based on signal components of the signal received by means of the antennas of the first subset;
determining a receiving direction of the signal in a second plane based on signal components of the signal received by means of the antennas of the second subset, wherein the first plane is aligned perpendicularly to the second plane; and
determining a position of the transceiver relative to the vehicle based on the receiving direction of the signal in the first plane and based on a receiving direction of the signal in the second plane.

20. The method as claimed in claim 19, further comprising determining the position of the transceiver in a first dimension along the longitudinal axis of the vehicle based on a received signal strength of the respective signal components determined by means of the respective antennas.

21. The method as claimed in claim 19, wherein further comprising determining the position of the transceiver in a second dimension along the transverse axis of the vehicle or in a third dimension along a vertical axis of the vehicle based on a phase difference of arrival of the respective signal components.

22. The method as claimed in claim 19, wherein the antennas are constructed identically.

23. The method as claimed in claim 19, wherein the first subset of antennas comprises at least one antenna module, which is arranged in the interior of the vehicle, and at least one antenna module, which is arranged outside the interior of the vehicle,
or wherein the first subset of antennas comprises four antennas which are arranged at the corners of the vehicle,
or wherein the first subset of antennas comprises two antennas which are arranged at the sides of the vehicle.

24. The method as claimed in claim 23, wherein two of the four antennas, which are arranged at the corners of the vehicle, are arranged such that two areas with the highest angle-of-arrival resolution of the two antennas overlap at the side of the vehicle.

25. The method as claimed in claim 19, wherein the antennas of the second subset of antennas are arranged in the interior of the vehicle.

26. The method as claimed in claim 19, wherein the antennas comprise two groups of antennas in each case, further comprising evaluating signals of a first polarization direction by means of the first of the two groups of antennas and evaluating signals of a second polarization direction by means of the second of the two groups of antennas.

27. A non-transient computer readable medium for determining a position of a transceiver relative to a vehicle, wherein the computer-readable medium comprises instructions which, when executed on a controller of the vehicle, causes the controller to:
evaluate an ultra-wideband, UWB, signal of a transceiver, which is received by means of a plurality of antennas, wherein the plurality of antennas comprises a first subset of one or more antennas and a second subset of one or more antennas;
determine a receiving direction of the signal in a first plane based on signal components of the signal received by means of the antennas of the first subset;
determine a receiving direction of the signal in a second plane based on signal components of the signal received by means of the antennas of the second subset, wherein the first plane is aligned perpendicularly to the second plane; and
determine a position of the transceiver relative to the vehicle based on the receiving direction of the signal in the first plane and based on a receiving direction of the signal in the second plane.

28. The non-transient computer readable medium of claim 27 further comprising instructions which, when executed on the controller of the vehicle, causes the controller to determine the position of the transceiver in a first dimension along the longitudinal axis of the vehicle based on a received signal strength of the respective signal components determined by means of the respective antennas.

29. The non-transient computer readable medium of claim 27 further comprising instructions which, when executed on the controller of the vehicle, causes the controller to determine the position of the transceiver in a second dimension along the transverse axis of the vehicle or in a third dimension along a vertical axis of the vehicle based on a phase difference of arrival of the respective signal components.

30. The non-transient computer readable medium of claim 27 wherein the antennas comprise two groups of antennas in each case, the non-transient computer readable medium further comprising instructions which, when executed on the controller of the vehicle, causes the controller to evaluate signals of a first polarization direction by means of the first of the two groups of antennas and evaluating signals of a second polarization direction by means of the second of the two groups of antennas.
